(19) United States
(12) Patent Application Publication
(10) Pub. No.: US 2026/0233420 A1
(43) Pub. Date: Aug. 13, 2026

(54) MANUAL TOOL

(71) Applicant: Sachikuru Co., Ltd., Ehime (JP)

(72) Inventor: Hiroshi Murakami, Ehime (JP)

(73) Assignee: Sachikuru Co., Ltd., Ehime (JP)

(21) Appl. No.: 19/437,345

(22) Filed: Dec. 31, 2025

(30) Foreign Application Priority Data
Feb. 12, 2025 (JP) 2025-020455

(51) Int. Cl. B26B 17/00; B25G 1/10

(52) U.S. Cl. CPC B26B 17/00; B25G 1/102

(57) ABSTRACT

A manual tool includes a pair of main body members having a work part on a front end side and having grip operation parts on a rear end side; and a connection part that rotatably supports the pair of main body members in a crossed state. The work part opens and closes by opening and closing operation of the grip operation parts. The grip operation part includes a replaceable gripping member with decorative processing applied thereto. The work part includes a pair of work members and an opening prevention mechanism for the work members. The pair of main body members and the gripping members are provided with mounting holes for fixing the gripping members to the main body members. The gripping member is provided with an insertion hole for insertion of a front end of the grip operation part of the main body members.

### CROSS-REFERENCE TO RELATED APPLICATION

This application claims the priority benefits of Japanese application no. 2025-020455, filed on February 12, 2025. The entirety of the above-mentioned patent application is hereby incorporated by reference herein and made a part of this specification.

### BACKGROUND

### Technical Field

The disclosure relates to a manual tool including a work part and grip operation parts.

### Related Art

Manual tools such as nippers exist that are designed with ingenuity to exhibit their functions. In particular, plastic nippers place emphasis on the pursuit of sharpness performance, and cutting performance has achieved evolution.

However, conventional manual tools emphasize ease of use, function, durability, and the like, and decorative elements are not considered. In particular, grip portions and the like have followed the same shape for the past decades, and no evolution in functional aspects is observed.

### Citation List

### Patent Document

[Patent Document 1] Japanese Patent No. 7465605

Conventional manual tools do not consider design characteristics that satisfy hobby preferences, and cannot provide the joy of ownership or the pleasure of collecting. Moreover, in the case where parts are damaged, it is necessary to replace the entire tool, resulting in a large economic burden.

The disclosure is made to solve the above problems, and aims to provide a manual tool that achieves both design characteristics and functionality, and enables parts replacement.

### SUMMARY

The manual tool of the disclosure includes a pair of main body members having a work part on a front end side and having grip operation parts on a rear end side; and a connection part that rotatably supports the pair of main body members in a crossed state. The work part opens and closes by opening and closing operation of the grip operation parts. The grip operation part includes a replaceable gripping member with decorative processing applied thereto. The work part includes a pair of work members and an opening prevention mechanism for the work members. The pair of main body members and the gripping members are provided with mounting holes for fixing the gripping members to the main body members. The gripping member is provided with an insertion hole for insertion of a front end of the grip operation part of the main body members.

### BRIEF DESCRIPTION OF THE DRAWINGS

FIG. 1 is an overall view of a manual tool according to an embodiment of the disclosure.

FIG. 2 is a view showing main body members of the manual tool according to an embodiment of the disclosure.

FIG. 3 is a view showing gripping members of the manual tool according to an embodiment of the disclosure.

FIG. 4 is a perspective view showing an assembled state of main body members and gripping members of the manual tool according to an embodiment of the disclosure.

### DESCRIPTION OF THE EMBODIMENTS

According to the disclosure, since decorative processing is applied to the gripping members, it is possible to obtain not only functionality as a tool, but also the joy of ownership and the pleasure of collecting.

Moreover, since the gripping members have an exchangeable structure, parts replacement when damaged is easy and economical.

Hereinafter, embodiments of the disclosure will be described. The manual tool of the disclosure includes a pair of main body members, and each main body member has a work part on the front end side and a grip operation part on the rear end side. The pair of main body members are arranged so as to cross each other at a connection part and are rotatably supported.

The grip operation part is provided with exchangeable gripping members having decorative processing applied thereto. The gripping members are fixed by mounting members through mounting holes provided in the pair of main body members and the gripping members.

The work part has a pair of work members, and particularly in the case of use as a nipper, is configured as a pair of blade parts. Moreover, the work part is provided with an opening prevention mechanism, such that the work part may be stored in a closed state when stored.

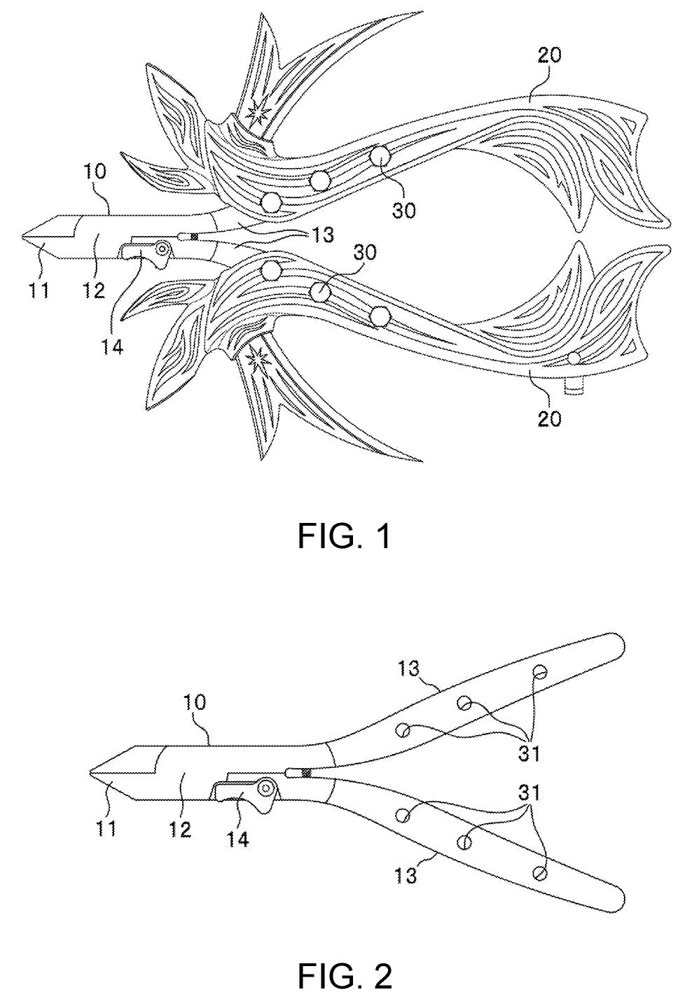

As shown in FIG. 1, the manual tool of the embodiment includes a pair of main body members 10, gripping members 20, and mounting members 30.

A pair of main body members 10 include a work part 11 on a front end side and grip operation parts 13 on a rear end side. The pair of main body members 10 are arranged to cross each other at a connection part 12 and are rotatably supported. The work part 11 is provided with an opening prevention mechanism 14.

As shown in FIG. 2, the grip operation part 13 of the main body member 10 is provided with mounting holes 31. The mounting holes 31 are configured to fix the gripping member 20 to the main body member 10.

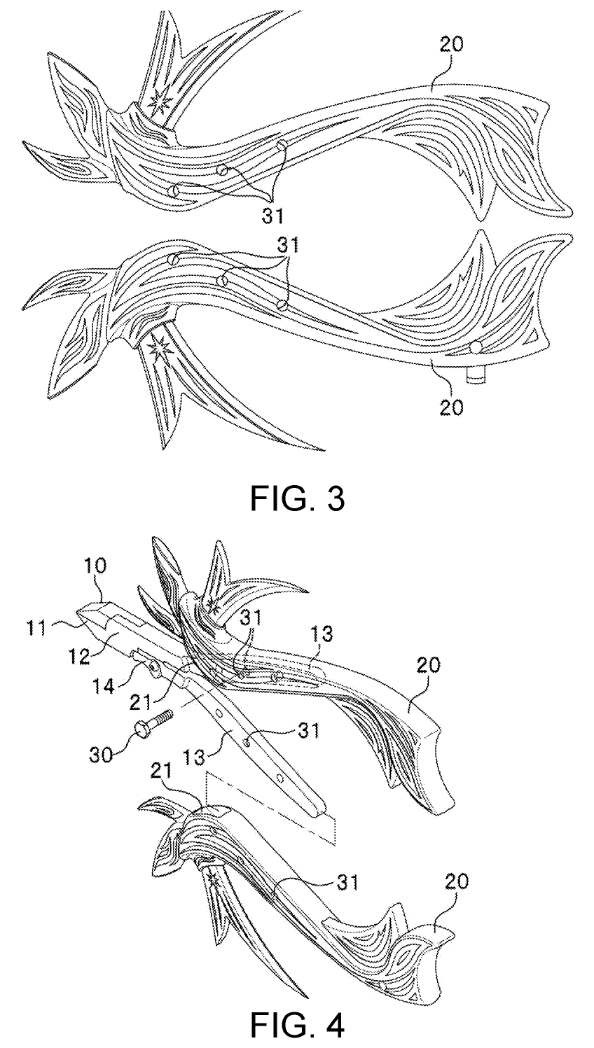

As shown in FIG. 3, the gripping member 20 has decorative processing applied thereto, and is provided with the mounting holes 31 at positions corresponding to the main body member 10.

As shown in FIG. 4, the gripping member 20 is provided with an insertion hole 21, and by inserting the front end of the grip operation part 13 of the main body member 10 into the insertion hole 21, the gripping member 20 may be mounted to the grip operation part 13 of the main body member 10, and by inserting the mounting member 30 through each mounting hole 31, the gripping member 20 may be fixed to the main body member 10. With this structure, replacement of the gripping member 20 may be easily performed.

In the embodiment, the main body member 10 is formed mainly from metal material. The gripping member 20 may be formed from metal material or resin material. As the metal material, for example, stainless steel, aluminum alloy, titanium alloy, and the like may be used. As the resin material, for example, ABS resin, polycarbonate, reinforced plastic, and the like may be used.

The decorative processing of the gripping member 20 may be applied in various aspects. For example, excavation processing that forms uneven patterns on the surface, three-dimensional processing that forms three-dimensional protrusions and recesses, multi-color painting by coloring treatment, metallic luster treatment, pattern formation by laser processing, etching processing, anodizing treatment, and the like may be raised. These decorative processings may be applied individually or in combination.

Moreover, the gripping member 20 may be provided with portions having auxiliary functions. For example, a protrusion part that functions as a scraper, a front end part that may be configured as a driver, a notch portion that functions as a wire stripper, and the like may be provided. Thereby, the gripping member 20 may include not only decorative elements but also practical functions.

The gripping member 20 is prepared with multiple variations having various shapes and functions, and may be replaced according to the user's preference and application. For example, various variations may be developed, such as gripping members of different sizes to suit different hand sizes, gripping members with curved shapes that emphasize grip comfort, gripping members with uneven shapes that improve finger grip, gripping members equipped with functions suitable for specific work, and the like. Thereby, users may enjoy multiple gripping members as a collection.

The manual tool of the disclosure may be applied not only to nippers but also to various types of manual tools. For example, by changing the shape and function of the work part 11, various manual tools such as pliers, needle-nose pliers, pliers, wire strippers, crimping tools, and the like may be realized. In the embodiment, a nipper is shown as an example, but the disclosure is not limited thereto.

Note that the disclosure is not limited to the above embodiment. For example, as the mounting member 30, various forms such as screws, pins, and the like may be configured. Moreover, regarding the structure of the opening prevention mechanism 14, various forms such as slide type, rotary type, and the like may be adopted.

The manual tool of the embodiment is manufactured by the following steps. First, the main body member 10 is formed from a metal material by cutting processing. Next, the gripping member 20 is manufactured from a metal material by cutting processing, or from a resin material by injection molding. Thereafter, the main body member 10 and the gripping member 20 are assembled by the mounting member 30. The decorative processing may be applied during the manufacturing step of the gripping member 20 or after manufacturing.

### Industrial Applicability

The manual tool of the disclosure may be utilized in various industrial fields such as DIY, electrical work, assembly of precision equipment, and the like, as a tool that combines both functionality and decorativeness. In particular, it is useful in tool markets that emphasize design and tool markets with high collectibility. Moreover, since it has a structure that enables parts replacement, it is excellent in repairability and maintainability, and is suitable for long-term use.

### Reference Signs List

10 main body member

11 work part

12 connection part

13 grip operation part

14 opening prevention mechanism

20 gripping member

21 insertion hole

30 mounting member

31 mounting hole

What is claimed is:

1. A manual tool, comprising:
a pair of main body members having a work part on a front end side and having grip operation parts on a rear end side; and
a connection part that rotatably supports the pair of main body members in a crossed state,
wherein the work part opens and closes by opening and closing operation of the grip operation parts,
wherein the grip operation part comprises a replaceable gripping member with decorative processing applied thereto,
the work part comprises a pair of work members and an opening prevention mechanism for the work members,
the pair of main body members and the gripping members are provided with mounting holes for fixing the gripping members to the main body members, and
the gripping member is provided with an insertion hole for insertion of a front end of the grip operation part of the main body members.

2. The manual tool according to claim 1, wherein mounting members for fixing the gripping members to the main body members are inserted through the mounting holes.

3. The manual tool according to claim 1,
wherein the work part is a pair of blade parts for performing cutting work,
and the manual tool is a nipper.

4. The manual tool according to claim 2,
wherein the work part is a pair of blade parts for performing cutting work,
and the manual tool is a nipper.
